(19) United States
(12) Patent Application Publication
(10) Pub. No.: US 2025/0245254 A1
(43) Pub. Date: Jul. 31, 2025

(54) QUERY PROCESSING

(71) Applicant: Beijing Zitiao Network Technology Co., Ltd., Beijing (CN)

(72) Inventors: Yile Zhang, Beijing (CN); Chunhui Li, Beijing (CN); Bo Wang, Beijing (CN); Wei Li, Beijing (CN)

(21) Appl. No.: 18/944,504

(22) Filed: Nov. 12, 2024

(30) Foreign Application Priority Data
Jan. 31, 2024 (CN) 202410137529.1

(51) Int. Cl. G06F 16/33; G06F 40/30

(52) U.S. Cl. CPC G06F 16/3344; G06F 40/30

(57) ABSTRACT

Embodiments of the disclosure provide a method, apparatus, device and readable medium for query processing. The method includes: segmenting a target document into a plurality of document segments at least based on structural information of the target document and a semantic analysis result of the target document, the structural information at least indicating a hierarchical structure of the target document; generating a respective document vectorized representation of each of the plurality of document segments; and using the document vectorized representations to perform data retrieval against the target document. According to the embodiments of the present disclosure, it may be ensured that each document segment may have a complete semantic. This helps to improve the accuracy and comprehensiveness of data retrieval results and provide query responses that better match the intention of the user.

### CROSS-REFERENCE

This application claims priority to Chinese patent application No. 2024101375291, filed on Jan. 31, 2024, and entitled “METHOD, APPARATUS, DEVICE AND READABLE MEDIUM FOR QUERY PROCESSING”, which is incorporated herein by reference in its entirety.

### FIELD

Example embodiments of the present disclosure generally relate to the computer field, and more particularly, to query processing.

### BACKGROUND

With the progress of information technology, various terminal devices can provide a wide range of services to people in the aspects of work, life, and so on. An application providing a service may be deployed in a terminal device. The terminal device presents corresponding content to, and performs interaction with, a user through a user interface of the application, thereby satisfying requirements of the user. In some cases, the user may initiate a data retrieval request within the application, at which point a query response desired by the user needs to be returned in conjunction with a corresponding database. Therefore, how to improve the quality of a query service provided to a user is an issue of concern.

### SUMMARY

In a first aspect of the present disclosure, a method of query processing is provided. The method comprises: segmenting a target document into a plurality of document segments, the segmenting being at least based on structural information of the target document and a semantic analysis result of the target document, the structural information at least indicating a hierarchical structure of the target document; and generating a respective document vectorized representation of each of the plurality of document segments; and using the document vectorized representations to perform data retrieval against the target document.

In a second aspect of the present disclosure, an apparatus for query processing is provided. The apparatus comprises: a document segmenting module configured to segment a target document into a plurality of document segments at least based on structural information of the target document and a semantic analysis result of the target document, the structural information at least indicating a hierarchical structure of the target document; and a representation generating module configured to generate respective document vectorized representations of the plurality of document segments. The document vectorized representations can be used to perform data retrieval against the target document.

In a third aspect of the present disclosure, an electronic device is provided. The electronic device comprises: at least one processing unit; and at least one memory coupled to the at least one processing unit and storing instructions executable by the at least one processing unit, the instructions, when executed by the at least one processing unit, causing the electronic device to perform operations that implement the method of the first aspect of the present disclosure.

In a fourth aspect of the present disclosure, a computer readable storage medium is provided. The computer readable storage medium has a computer program stored thereon, wherein the computer program is executable by a processor to perform operations that implement the method of the first aspect of the present disclosure.

It should be understood that what is described in this Summary is not intended to identify key features or essential features of the implementations of the present disclosure, nor is it intended to limit the scope of the present disclosure. Other features disclosed herein will become easily understandable through the following description.

### BRIEF DESCRIPTION OF THE DRAWINGS

The above and other features, advantages, and aspects of respective implementations of the present disclosure will become more apparent from the following detailed description with reference to the accompanying drawings. The same or similar reference numerals represent the same or similar elements throughout the figures, where:

FIG. 1 illustrates a schematic diagram of an example environment.

FIG. 2 illustrates a flowchart of an example process for query processing.

FIG. 3 illustrates a schematic diagram of an example of a document tree structure.

FIG. 4 illustrates a schematic diagram of an example process for query processing.

FIG. 5 illustrates a block diagram of an example apparatus for query processing.

FIG. 6 illustrates a block diagram of an example electronic device.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are provided for illustrative purposes only and are not intended to limit the scope of protection of the present disclosure.

In the description of the embodiments of the present disclosure, the term “including”, and the like should be understood as non-exclusive inclusion, that is, “including but not limited to”. The term “based on” should be understood as “based at least in part on.” The term “one embodiment” or “the embodiment” should be understood as “at least one embodiment”. The term “some embodiments” should be understood as “at least some embodiments”. Other explicit and implicit definitions may further be included below.

In this specification, unless explicitly stated otherwise, performing a step “in response to A” does not mean that the step is performed immediately after “A”, but may include one or more intermediate steps.

It will be appreciated that the data involved in the technical solution (including but not limited to the data itself, the obtaining or use of the data) should comply with the requirements of the corresponding legal regulations and related provisions.

It will be appreciated that, before using the technical solutions disclosed in the various embodiments of the present disclosure, the user shall be informed of the type, application scope, and application scenario of the personal information involved in this disclosure in an appropriate manner and the user's authorization shall be obtained, in accordance with relevant laws and regulations. The related users may include any type of right holder, such as individuals, enterprises, and groups.

For example, in response to receiving an active request from a user, prompt information is sent to the relevant user to explicitly prompt the relevant user. An operation requested to be executed by the user needs to obtain and use information of a related user, so that the related user may autonomously select, according to prompt information, whether to provide information for software or hardware such as an electronic device, an application, a server, or a storage medium that executes the operations of the technical solutions of the present disclosure.

As an optional but non-limiting implementation, in response to receiving an active request from the user, prompt information is sent to the user, for example, in the form of a pop-up window, and the pop-up window may present the prompt information in the form of text. In addition, the pop-up window may further carry a selection control for the user to select whether he/she “agrees” or “disagrees” to provide personal information to the electronic device.

It should be understood that the above notification and user authorization process are only illustrative which do not limit the implementation of this disclosure. Other methods that meet relevant laws and regulations can also be applied to the implementation of this disclosure. In the embodiments of the present disclosure, the enabling of relevant functions, acquired data, data processing, storage mode and so on shall be subject to the prior authorization of the user and other rights holders associated with the user, and shall comply with relevant laws and regulations and the agreement of rules between rights holders.

As used herein, the term “model” may refer to a structure that learns association between corresponding inputs and outputs from training data, so that after the training is complete, a corresponding output may be generated for a given input. The generation of the model may be based on machine learning technology. Deep learning is a machine learning algorithm that processes inputs and provides corresponding outputs by using a multi-tiered processing unit. A neural network model is one example of a model based on deep learning. Herein, “model” may further be referred to as “machine learning model”, “learning model”, “machine learning network”, or “learning network”, which may be used interchangeably herein.

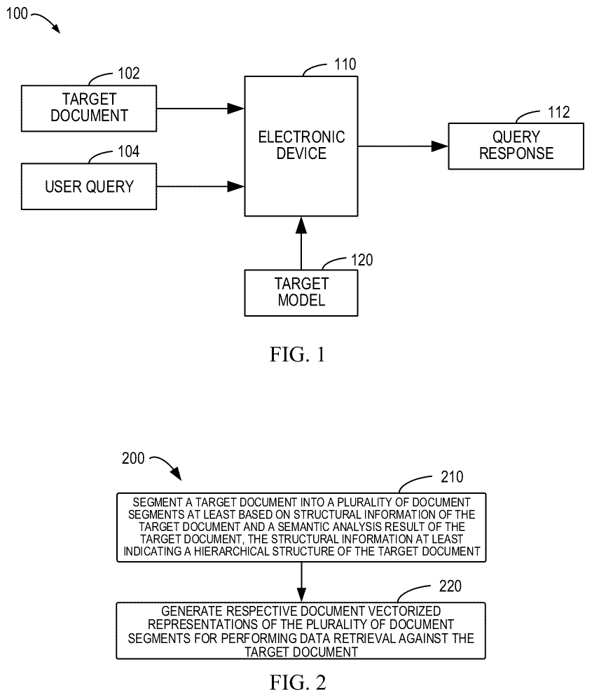

FIG. 1 shows a schematic diagram of an example environment 100 in which embodiments of the present disclosure can be implemented. In the environment 100, an electronic device 110 may obtain a target document 102 and a user query 104. The target document 102 may include one or more documents in any suitable format (including, but not limited to, doc, pdf, txt, etc.). The target document 102 may further include any suitable type of data information (including, but not limited to, text, pictures, tables, etc.). Although a single document is shown, there may be a plurality of documents, and the user query might have to look for matching data in the plurality of documents. The user query 104 may, for example, indicate a query for data associated with the target document 102.

The electronic device 110 may generate a query response 112 to the user query 104 based on the target documents 102 and the user query 104. The query response 112, for instance, may include at least a portion of content in the target document 102 that matches the user query 104.

In some embodiments, the electronic device 110 may generate, based on the target document 102 and the user query 104, a corresponding query response 112 using a target model 120. The target model 120 may include one or more models. The target model 120 may run locally on the electronic device 110 or on a further electronic device (e.g., a remote server). In some embodiments, the target model 120 may be a machine learning model, a deep learning model, a learning model, a neural network, etc. In some embodiments, the model may be based on a language model (LM). The language model can be provided with question and answer capabilities by learning from a large corpus. The target model 120 may further be based on other suitable models.

The electronic device 110 may be any suitable type of computing-capable device, including a terminal device or a server device. The terminal device may be any suitable type of mobile terminal, fixed terminal, or portable terminal, including a mobile handset, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals for these devices, or any combination thereof. The server device may include, for example a computing system/server, such as a mainframe, an edge computing node, a computing device in a cloud environment, etc. In some embodiments, the management platform 110 may be implemented based on a cloud service.

It should be understood that the structure and function of the environment 100 are described for exemplary purposes only and are not intended to imply any limitation on the scope of the present disclosure.

As mentioned above, how to improve the quality of a query service provided to a user is an issue of concern. In order to improve data retrieval efficiency, indexes of documents are usually pre-selected and built. Currently, document index characterization based on a vectorized representation is also proposed, i.e., dividing a document into a plurality of document segments, and constructing and storing a vectorized representation corresponding to each document segment. At the time of the retrieval, document segments associated with a user query are retrieved by comparing a vectorized identification corresponding to the user query with the vectorized representations corresponding to the document segments to form a query response.

Conventionally, a document is usually directly divided into a plurality of document segments of the same size according to a fixed size, or a plurality of document segments are determined directly based on paragraph division of a target document. However, a fixed-size segmenting approach may lead to incomplete semantic information in a single document segment. On the other hand, if the document segments are divided directly according to paragraph granularity, sizes of different document segments are very irregular, which affects a vector representation effect. In a document, there may be a plurality of paragraphs that echo back and forth, as well as a plurality of paragraphs that may be semantically similar. Traditionally, a segmentation method cannot incorporate the results of semantic analysis of the target document, which may lead to the problem of incomplete semantics and missing information in the document fragments obtained by cutting. This may affect the accuracy of a query response to be determined subsequently, and thus the quality of the query service provided to the user.

In view of this, an embodiment of the present disclosure provides an improved method of query processing. The method comprises: segmenting a target document into a plurality of document segments at least based on structural information of the target document and a semantic analysis result of the target document, the structural information at least indicating a hierarchical structure of the target document; and generating respective document vectorized representations of the plurality of document segments for performing data retrieval against the target document.

In this way, by considering the structural information of the target document and combining semantic analysis, a flexible segmentation boundary may be determined for the document, so that document segments resulting from the segmentation are semantically continuous and complete. This helps to improve the accuracy and comprehensiveness of the data retrieval result and provides a query response that better matches the intention of the user.

Some example embodiments of the present disclosure will be described below with reference to the accompanying drawings.

FIG. 2 illustrates a flowchart of an example process 200 for query processing according to some embodiments of the disclosure. The process 200 may be implemented at the electronic device 110. For ease of discussion, the process 200 will be described with reference to the environment 100 of FIG. 1.

At block 210, the electronic device 110 segments the target document 102 into a plurality of document segments at least based on structural information of the target document 102 and a semantic analysis result of the target document 102, the structural information at least indicating a hierarchical structure of the target document 102. The hierarchical structure of the target document 102 may indicate, for example, headings, subheadings, and content under different headings/subheadings of the target document 102.

In some embodiments, the electronic device 110 may perform a semantic analysis of the target document 102 based on a predetermined rule or algorithm to obtain a semantic analysis result. Alternatively or in addition, in some embodiments, the electronic device 110 may further determine a semantic analysis of the target document 102 with a semantic analysis model. For example, the electronic device 110 may provide the target document 102 as at least a portion of model input to a semantic analysis model and obtain model output indicative of the semantic analysis of the target document 102 from the semantic analysis model. The semantic analysis model may include, but is not limited to, a perceptron, a multilayer perceptron (MLP), a convolutional neural network (CNN), a feedforward neural network (FNN), a fully-connected neural network (FCN), a Transformer, a recurrent neural network (RNN), and the like. The present disclosure does not limit a specific model. The semantic analysis results may be indicative of semantic information in the target document 102 that may be used to guide segmentation of the target document 102.

In embodiments of the present disclosure, the electronic device 110 may determine segmentation boundaries between the respective document segments when segmenting the target document 102 based on the structural information of the target document 102 and the semantic analysis result of the target document 102. Each document segment may be limited by adjacent segmentation boundaries. In some embodiments, by using the semantic analysis result of the target document 102, the respective document segments after the segmentation may enable semantic integrity. That is, the plurality of document segments determined by the electronic device 110 based on the plurality of segmentation boundaries all have complete semantics, and there are no abrupt semantic breaks, semantic discontinuities or semantic jumps within the document segments. As such, subsequent data retrievals for the target document 102 may be better performed on the basis of document segments having semantic integrity.

In some embodiments, when segmenting the target document 102, it is further possible to make the plurality of segmented document segments have no overlap between them. This may reduce processing resource overheads for subsequent conversion of document segments into document vectorized representations and storage overheads for the document vectorized representations.

In some embodiments, the structural information further indicates a data type in the target document 102. The target document 102 may include data of a plurality of data types. Different data types may be divided based on different data modalities. Different data types or different data modalities may include text, tables, charts, images, video, knowledge maps, and so forth. In some embodiments, in response to detecting that at least partial data of the target document 102 contains data of a first data type and data of a second data type, the electronic device 110 may segment the at least partial data into a first document segment and a second document segment, i.e., a first document segment and a second document segment. The first document segment comprises the data of the first data type, and the second document segment comprises the data of the second data type. That is, during document segmentation, it is ensured that a single document segment contains continuous data of a single data type. Certainly, if two or more data types are found in a data portion of any granularity in the target document 102, the data portion may further be segmented into two or more document segments. In this way, in a document containing a plurality of data types, the segmentation boundaries of a document segment are to be determined between different data types, and the electronic device 110 can determine the document segments containing different data types via such segmentation boundaries.

In some embodiments, the electronic device 110 may subsequently generate a plurality of document vectorized representations (embedding) of the plurality of document segments, each of which may have a predetermined dimension. Therefore, in some embodiments, the electronic device 110 may further segment the target document 102 into a plurality of document segments further based on a dimension of the document vectorized representations to be generated. The larger the dimension of the document vectorized representation, the more accurately data of a larger size can be characterized. Thus, for the same target document 102, the larger the dimension of the document vector representation to be generated, the fewer segmentation boundaries can be determined by the electronic device 110, and the larger the determined document segment. For example, if the dimension of the document vector representation to be generated is 512-dimensional, the electronic device 110 may determine more segmentation boundaries in the target document 102 to determine a number (e.g., a first number) of smaller document segments. If the dimension of the document vector representation to be generated is 1024-dimensional or 2048-dimensional, the electronic device 110 may determine fewer segmentation boundaries in the target document 102 to determine a number (e.g., a second number) of larger document segments. It is to be appreciated that the first number should be greater than the second number for the same target document 102.

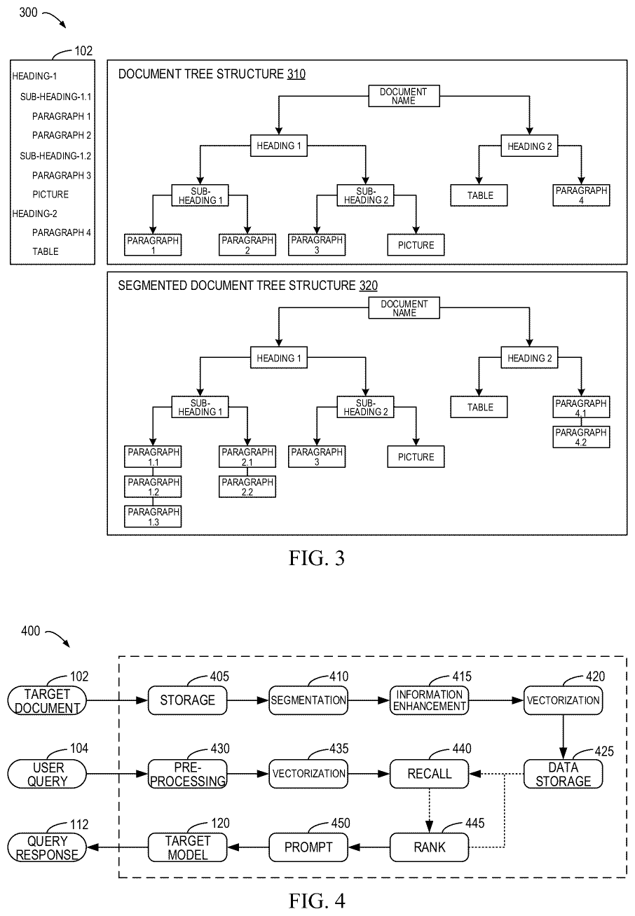

In some embodiments, the hierarchical structure of the target document 102 includes a document tree structure of the target document 102. Certainly, the hierarchical structure may further include any other proper structure (for example, a knowledge map), which is not limited in the present disclosure. Hereinafter, a document tree structure is taken for example for description. FIG. 3 illustrates a schematic diagram of an example 300 of a document tree structure according to some embodiments of the present disclosure. As shown in FIG. 3, the hierarchical structure of the target document 102 may include a document tree structure 310. In some embodiments, the electronic device 110 may, for data corresponding to respective leaf nodes (e.g., node “Paragraph 1”, node “Paragraph 2”, node “Paragraph 3”, node “Picture”, node “Table”, and node “Paragraph 4” shown in the figure) in the document tree structure 310, segment the target document 102 into a plurality of document segments based at least on a semantic analysis result of the data corresponding to the respective leaf nodes. The respective leaf nodes of the document tree structure 310 may indicate paragraphs under respective headings in the target document 102, as well as data of different data types.

The electronic device 110 may, for example, for data corresponding to respective leaf nodes in the document tree structure 310, segment data corresponding to each leaf node into at least one document segment based at least on a semantic analysis result of the data corresponding to each leaf node. The electronic device 110 may, for example, perform segmentation on the data corresponding to the respective leaf nodes of the document tree structure 310 to determine a segmented document tree structure 320 of the target document 102. As shown in FIG. 3, for the segmented document tree structure 320, the data corresponding to the node “Paragraph 1” may be segmented into “Paragraph 1.1, Paragraph 1.2 and Paragraph 1.3”, the data corresponding to the node “Paragraph 2” may be segmented into “Paragraph 2.1 and Paragraph 2.2”, and the data corresponding to the node “Paragraph 4” may be segmented into “Paragraph 4.1 and Paragraph 4.2”.Thus, the electronic device 110 may perform data segmentation on the target document 102 at the leaf nodes of the target document 102, at least in conjunction with the semantic analysis (e.g., further in conjunction with the data type and dimension of the document vectorized representation).

It should be noted that FIG. 3 is merely one example of document segmentation. In addition to segmenting document segments in conjunction with semantic analysis at paragraph granularity, in other embodiments, document segments may be further segmented in conjunction with semantic analysis at other granularities, e.g., at chapter granularity, or at the entire document granularity.

With the approach described above, the electronic device 110 may determine a plurality of segmentation boundaries for the target document 102 in conjunction with the data type of the target document 102, the semantic analysis of the target document 102, and the structural information of the target document 102, and such a plurality of segmentation boundaries may further be referred to as flexible segmentation boundaries. In turn, the electronic device 110 may obtain a plurality of document segments of the target document 102 with complete semantics based on the plurality of segmentation boundaries, and each document segment may include only data of a unique data type.

At block 220, the electronic device 110 generates respective document vectorized representations of the plurality of document segments for performing data retrieval against the target document 102. The electronic device 110 may, for example, separately perform vectorized coding on the plurality of document segments with an encoding model to obtain respective document vectorized representations of the plurality of document segments. It should be noted that since the plurality of document segments may include data of a plurality of data types, for different document segments including different data types, the electronic device 110 may perform the vectorized coding on different document segments with different encoding models. For example, the electronic device 110 may perform vectorized coding on document segments containing text data types with a first coding model, vectorized coding on document segments containing image data types with a second coding model, vectorized coding on document segments containing table data types with a third coding model, and so on.

In some embodiments, the electronic device 110 may further generate enhancement data for at least a portion of the target document 102. The enhancement data may include, for example, a reference question and answer pair (QA pair) constructed based on the at least a portion, or summary information extracted from the at least a portion, wherein the at least a portion comprises at least one document segment of the plurality of document segments. The electronic device 110 may determine the at least one document segment, for example, based on the structural information of the target document 102. For example, if a paragraph of the target document 102 is segmented to obtain the at least one document segment, the electronic device 110 may generate enhancement data based on the at least one paragraph of the target document 102 in paragraph units. Alternatively or in addition, the electronic device 110 may further generate enhancement data based on units larger than paragraphs (e.g., chapters, entire document).

For example, the electronic device 110 may construct reference question and answer pairs based on at least one of the plurality of document segments, and each of the reference question and answer pairs may include a reference query against the at least one document segment and a reference query response 112 to the reference query. The electronic device 110 may further perform content extraction on the at least one document segment to obtain summary information corresponding to the at least one document segment. The reference question and answer pair and/or the summary information herein may be determined by the electronic device 110 based on a predetermined rule or by means of a model, which is not limited in the present disclosure. In some embodiments, the enhancement data may further include other data, for example, may further include other document segments that have the same semantics as the at least a portion but different content. The electronic device 110 may, for example, perform an operation of expanding, replacing, abbreviating, or the like on content in the at least a portion to obtain other document segments, while ensuring that the semantics of the at least a portion do not change.

The electronic device 110 may generate an enhancement vectorized representation of the enhancement data. Likewise, the electronic device 110 may, for example, perform a vectorized coding on the enhancement data with the encoding model to obtain an enhancement vectorized representation of the enhancement data. The enhancement data may further include data of different data types. For different enhancement data including different data types, the electronic device 110 may perform vectorized coding on different enhancement data with different coding models. In turn, the electronic device 110 may store the enhancement vectorized representation in association with at least one respective document vectorized representation of the at least one document segment.

For example, if the target document 102 is divided into five document segments (a document segment A, a document segment B, a document segment C, a document segment D, and a document segment E) in total, the electronic device 110 further generates enhancement data A and enhancement data B corresponding to the document segment A and the document segment B respectively, and the electronic device 110 may obtain five document segments and two pieces of enhancement data. In turn, the electronic device 110 may obtain five document vectorized representations and two enhancement vectorized representations. The electronic device 110 may store the document vectorized representation A and the enhancement vectorized representation A corresponding to the document segment A and the enhancement data A in association with each other and store the document vectorized representation B and the enhancement vectorized representation B corresponding to the document segment B and the enhancement data B in association with each other. The electronic device 110 may store the five document vectorized representations and the two enhancement vectorized representations, for example, in the form of (document vectorized representation A and enhancement vectorized representation A), (document vectorized representation B and enhancement vectorized representation B), document vectorized representation C, document vectorized representation D and document vectorized representation E.

The electronic device 110 may perform data retrieval against the target document 102 based on the respective document vectorized representations and enhancement vectorized representations of the stored plurality of document segments. The electronic device 110 may receive the user query 104 against the target document 102. In some embodiments, the electronic device 110 may provide a query page for receiving the user query 104. The query page may include, for example, a query entry. The electronic device 110 may, in response to receiving the user input via the query entry (e. g., an input field), determine a user input as the user query 104. It will be appreciated that the user query 104 can be a query in any suitable form and language. For example, the user query 104 can be a query in textual form, a query in voice form, etc.

In turn, the electronic device 110, in response to receiving a user query 104, generates a query vectorized representation corresponding to the user query 104. The electronic device 110, for instance, may perform vectorized coding on the user query 104 using the coding model to obtain a query vectorized representation corresponding to the user query 104. The electronic device 110 may determine a plurality of match degrees between the query vectorized representation and respective document vectorized representations of the plurality of document segments, and selects, from the plurality of document segments, at least one first document segment matching the user query 104 based on the determined plurality of match degrees. The selection of at least one first document segment from the plurality of document segments may further be referred to as a document segment recall. The at least one first document segment herein may be, for example, a predetermined number of at least one first document segment with the highest match degree. The electronic device 110 may generate a query response 112 to the user query 104 based at least on the at least one first document segment. It will be appreciated that while document segmentation and the storage and recall of vectorized representations are described with reference to a single document in the drawings, in practical applications, vectorized representations of more documents may be constructed and stored. For the user query 104, one or more document segments in different documents may be recalled. Here, reference is made to the target document 102 for purposes of illustration only.

Segmenting document segments for storage may lead to fragmentation of stored data, and when data required by the user query exists in a plurality of associated document segments, there may be a case where missing recalled data results in incomplete reply content. Given this, in some embodiments, in addition to recalling a portion of the document segments based on a match of the query vectorized representation of the user query, the electronic device 110 may further recall more semantically relevant document segments in a multi-round recall manner. In some embodiments, the electronic device 110 may further determine at least one second document segment from the plurality of document segments that is having semantic relevance with to the at least one first document segment, based on the structural information of the target document 102 and semantic context of the at least one first document segment in the target document 102. The semantic context may refer to the semantic relevance of each first document segment in a paragraph (or more granular document portions at a larger granularity), or the semantic relevance of each document segment between paragraphs (or within the entire document).

The electronic device 110 may, for example, determine at least one second document segment for each first document segment to determine at least one second document segment having semantic relevance to the at least one first document segment. That is, after recalling the at least one first document segment, the electronic device 110 may further recall the at least one second document segment that has semantic relevance to the at least one first document segment through a multi-round recall policy (for example, a policy of determining, for each first document segment, whether to further recall the at least one second document segment). There may be many specific recall policies for the multi-round recall, and the electronic device 110 may recall different second document segments based on different recall policies. In turn, the electronic device 110 may generate a query response 112 to the user query 104 based on the at least one first document segment and the at least one second document segment.

With regard to a specific method for determining the at least one second document segment, in some embodiments, the electronic device 110 may, for each of the at least one first document segment, and in response to determining that a document portion of a predetermined granularity in which the first document segment is located comprises at least one further document segment, determine the at least one further document segment as the at least one second document segment. The predetermined granularity may be, for example, a paragraph, a chapter, a document, etc. The electronic device 110 may, for example, determine the document portion of the predetermined granularity where the first document segment is located, based on the structural information of the target document 102. For example, if the first document segment is in a first paragraph, and the first paragraph includes three document segments in total, the electronic device 110 may determine the remaining two document segments other than the first document segment in the first paragraph as the at least one second document segment. Thus, the electronic device 110 may recall all of the document segments within the same paragraph (or document portion of a larger granularity).

In some embodiments, the electronic device 110 may, for each of the at least one first document segment, further determine at least one further document segment of the plurality of document segments as the at least one second document segment based on a semantic relevance between the first document segment and a further document segment of the plurality of document segments. For example, for each first document segment, the electronic device 110 may determine a semantic relevance between a further document segment of the plurality of document segments and the first document segment. The electronic device 110 may, for example, determine the semantic relevance based on a predetermined rule, and/or using a model. In turn, the electronic device 110 may determine at least one further document segment with a semantic relevance higher than a threshold as the at least one second document segment. For example, if the target document 102 includes five document segments (document segment A, document segment B, document segment C, document segment D, and document segment E), and the electronic device 110 determines document segment A as the first document segment, the electronic device 110 may determine the semantic relevance between document segment A and the remaining four document segments, i.e., document segment B, document segment C, document segment D, and document segment E, and determine at least one document segment (e.g., document segment B and document segment C) having a semantic relevance higher than a threshold as the at least one second document segment. Thus, the electronic device 110 may recall at least one second document segment with a higher semantic relevance to the at least one first document segment in consideration of the global semantic information.

As previously mentioned, from the perspective of computational efficiency and storage overheads of the vectorized representation, there may be no overlap between the plurality of document segments segmented from the target document 102. In the data retrieval, by applying a multi-round recall policy, even if there is no overlap between document segments, enough related document segments can be recalled for constructing a query response without causing loss or insufficiency of the recalled information.

In some embodiments, a multi-round recall may include two rounds of recall. In some embodiments, a multi-round recall may include more than two rounds of recall. That is, after the second round of recall of the at least one second document segment with a relatively high semantic relevance to the at least one first document segment, a third round of recall may be continued based on the second document segment to obtain more document segments with a relatively high semantic relevance to the at least one second document segment. In some embodiments, the number of recalls for a plurality of rounds may be a preset number of rounds, and in some embodiments, it may further be determined whether to stop the recall based on other preset judgment conditions.

Further, as mentioned above, the electronic device 110 may generate enhancement data for the at least one document segment of the target document 102 and store the enhancement vectorized representation of the enhancement data in association with at least one respective document vectorized representation of the at least one document segment. In some embodiments, the electronic device 110 may further, in response to one or more of the at least one document segment being determined as matching the user query 104, determine a query response 112 to the user query 104 based on the one or more document segments and the enhancement data. That is, the electronic device 110 may determine the query response 112 based on the at least one first document segment, the at least one second document segment, and the corresponding enhancement data in response to the at least one first document segment and/or the at least one second document segment including a document segment having the corresponding enhancement data.

Since the user query 104 is generally in a text modality, the query response 112 to the user query 104 as determined by the electronic device 110 is also generally in a text modality. In a specific scenario (for example, a scenario in which the target document 102 includes multimodal data), the accuracy of the query response 112 may not be ensured. The electronic device 110 may, based on the foregoing different multi-round recall policies, may recall data of other modalities, such as a table, an image, or a video in the target document 102. Such data may further be required by the user and can be used to generate a more accurate query response 112 after being recalled.

Regarding a specific approach to generating the query response 112, in some embodiments, the electronic device 110 may generate a prompt input for a target model (e.g., the target model 120 in FIG. 1) based at least on the at least one first document segment and the user query 104. As can be appreciated, in some embodiments, the electronic device 110 may further generate a prompt input for the target model based on the at least one first document segment, the at least one second document segment, and the user query 104. The electronic device 110 may provide the prompt input to the target model and obtain a model output from the target model indicative of the query response 112 to the target query. In turn, the electronic device 110 may generate a query response 112 to the user query 104 based on the model output.

In some embodiments, in addition to the user query 104 input by the user, the electronic device 110 may furtherly generate more relevant queries (also referred to as at least one further query) by rewriting the user query 104 in data retrieval process. The generated at least one further query may be, for example, a query resulting from performing any suitable operation, such as a summarization operation, an expansion operation, a keyword replacement operation, etc., on the user query 104. By expanding a new query from the original user query 104, it is possible to make the determined query response 112 better match the intention of the user as much as possible. In some embodiments, the electronic device 110 may generate at least one first further query for the user query 104 based on context information related to the user query 104 in the target application. The first further query may be understood as a rewrite to the user query 104. The context information used may include, for example, historical query records in the target application of the user that initiated the user query 104, time information when the user query 104 was initiated, etc.

The electronic device 110 may extract target information related to the user query 104 from the contextual information and use the target information to perform at least one of a replacing or supplement of at least some of the information in the user query 104 to derive at least one first further query. The extracted target information may include, for example, keywords, time information, etc. The target information herein may be, for example, extracted by the electronic device 110 from the contextual information based on a pre-obtained rule or any suitable algorithm. Alternatively or in addition, in some embodiments, the target information herein may further be extracted by the electronic device 110 from the contextual information using any suitable model.

In some embodiments, additionally or alternatively, the electronic device 110 may further generate at least one additional second query with a semantic relevance to the user query 104 based on the user query 104. The additional second query may be an expansion of the user query 104 to generate more expressions for related semantics based on the semantics of the user query 104. In some embodiments, the electronic device 110 may generate the additional second query directly from the original user query 104. In some embodiments, the electronic device 110 may first generate one or more additional first queries from the original user query 104 based on the contextual information and generate at least one additional second query with a semantic relevance to the additional first query on the basis of some or each additional first query. The at least one additional second query may include, for example, a query resulting from the electronic device 110 performing a summarization of the user query 104 and/or one or more keywords in the first further query, a query resulting from a refinement of the user query 104 and/or one or more keywords in the additional first query, a query resulting from a language translation of the user query 104 and/or the additional first query, etc.

The electronic device 110 may, for example, separately determine the at least one document segment (including at least one first document segment and at least one second document segment obtained via a multi-round recall) that matches the user query 104 and the enhancement data (if the enhancement data is included), the at least one further document segment (including at least one first further document segment and at least one second further document segment derived via a multi-round recall) to the at least one additional query (including at least one additional first query and at least one additional second query), and the enhancement data (if included). In some embodiments, the electronic device 110 may generate the query response 112 to the user query 104 directly based on the at least one document segment, the at least one further document segment, and the enhancement data.

Alternatively or in addition, in some embodiments, to reduce computational effort and improve computational efficiency, the electronic device 110 may further determine a set of document segments (including one or more document segments) from the at least one document segment and the at least one further document segment and generate the query response 112 to the user query 104 based only on the set of document segments. In particular, the electronic device 110 may determine a degree of match between the at least one document segment and the at least one further document segment and a corresponding one of the user query 104 and the further query. In turn, the electronic device 110 may rank the at least one document segment and the at least one further document segment based on the determined plurality of degrees of match. The electronic device 110 may select a set of document segments (e.g., a set of document segments with the highest degree of match) from the at least one document segment and the at least one further document segment based on a ranking result and generate a query response 112 to the user query 104 based on the selected set of document segments. In some embodiments, the electronic device 110 may further present the query response 112 to the user. For example, the electronic device 110 may present the query response 112 in a query page in any suitable form (e.g., card, window, etc.).

FIG. 4 illustrates a schematic view of an example process 400 for query processing according to some embodiments of the present disclosure. As shown in FIG. 4, after obtaining the target document 102, the electronic device 110 may first store 405 the target document 102. The electronic device 110 may perform a segmentation (410) operation on the stored target document 102 (namely, segmenting the target document 102) to obtain a plurality of document segments. The electronic device 110 may further perform information enhancement (415) based on at least one of the plurality of document segments to generate enhancement data for at least a portion of the target document 102. The electronic device 110 may perform a vectorization operation (420) on the plurality of document segments and the enhancement data to generate a plurality of document vectorized representations and enhancement vectorized representations. In turn, the electronic device 110 may perform data storage on the plurality of document vectorized representations and the enhancement vectorized representations (425). It should be noted that the enhancement vectorized representations are stored in association with respective document vectorized representations of the respective at least one document segment.

The electronic device 110 may further receive the user query 104. In response to receiving the user query 104, the electronic device 110 may perform preprocessing (430) operations on the user query 104, such as normalization, content completion, reference disambiguation, content rewriting. In turn, the electronic device 110 may perform a vectorization operation (435) on the preprocessed user query 104 to generate a query vectorized representation of the user query 104. The electronic device 110 may perform a recall (440) operation based at least on the query vectorized representation and the previously stored plurality of document vectorized representations.

In particular, the electronic device 110 may determine a plurality of match degrees between the query vectorized representation and respective document vectorized representations of the plurality of document segments, and selects, from the plurality of document segments, at least one first document segment matching the user query 104 based on the determined plurality of match degrees. The electronic device 110 may further determine, from the plurality of document segments, at least one second document segment having semantic relevance with the at least one first document segment based on the structural information of the target document 102 and a semantic context of the at least one first document segment in the target document 102. The electronic device may further determine enhancement data corresponding to the document segment if the document segment including the respective enhancement data is present in the at least one first fragment and/or the at least one second document segment. That is, the electronic device 110 may include at least one first document segment, at least one second document segment, and enhancement data matching the user query 104 in the recall result obtained by performing the recall operation.

The electronic device 110 may rank the plurality of document segments included in the recall results based on, for example, a degree of match between each recall result and the user query 104 (445). The electronic device 110, for instance, may determine one or more document segments (e.g., top N document segments) with the highest degree of match from the recall results. The electronic device 110 may further determine the respective enhancement data if a document segment including the respective enhancement data exists in the plurality of document segments. In turn, the electronic device 110 may generate a prompt (450) input for the target model 120 based on the plurality of document segments (and enhancement data). The electronic device 110 may provide the prompt input to the target model 120, obtain an output of the target model 120, and generate a query response 112 to the user query 104 based on the output.

In summary, in embodiments of the present disclosure, a plurality of document segments included in a target document 102 may be determined based at least on structural information of the target document 102 and semantic analysis of the target document 102. The data retrieval for the target document 102 may be performed based on the document vectorized representations of each of the plurality of document segments. Thus, it may be ensured that each document segment may have complete semantics. This helps improve the accuracy and comprehensiveness of the data retrieval result and provides a query response 112 that complies with an intention of the user.

Embodiments of the present disclosure also provide a corresponding apparatus for implementing the methods or processes described above. FIG. 5 illustrates a block diagram of an example apparatus 500 for query processing in accordance with certain embodiments of the present disclosure. The apparatus 500 may be implemented as or included in the electronic device 110. The various modules/components in the apparatus 500 may be implemented by hardware, software, firmware, or any combination thereof.

As shown in FIG. 5, the apparatus 500 comprises a document segmenting module 510 configured to segment a target document into a plurality of document segments at least based on structural information of the target document and a semantic analysis result of the target document, the structural information at least indicating a hierarchical structure of the target document. The apparatus 500 also comprises a representation generating module 520 configured to generate respective document vectorized representations of each of the plurality of document segments. The document vectorized representations can then be used to perform data retrieval against the target document.

In some embodiments, the document segmenting module 510 is further configured to segment the target document into a plurality of document segments based on the structural information of the target document and the semantic analysis result of the target document such that a length of each document segment is selected to maintain semantic integrity of the document segment.

In some embodiments, the apparatus 500 further comprises: a query vector generating module configured to, in response to receiving a user query, generate a query vectorized representation corresponding to the user query; a match degree determining module configured to determine a plurality of match degrees between the query vectorized representation and respective document vectorized representations of the plurality of document segments; a segment selecting module configured to select, from the plurality of document segments, at least one first document segment matching the user query based on the determined plurality of match degrees; and a query response generating module configured to generate a query response to the user query based at least on the at least one first document segment.

In some embodiments, the query response generating module is further configured to: determine, from the plurality of document segments, at least one second document segment having semantic relevance with the at least one first document segment based on the structural information of the target document and a semantic context of the at least one first document segment in the target document; and generate a query response to the user query based on the at least one first document segment and the at least one second document segment.

In some embodiments, the query response generating module is further configured to: for each of the at least one first document segment, in response to determining that a document portion of a predetermined granularity in which the first document segment is located comprises at least one further document segment, determine the at least one further document segment as the at least one second document segment; or for each of the at least one first document segment, determine at least one further document segment of the plurality of document segments as the at least one second document segment based on a semantic relevance between the first document segment and a further document segment of the plurality of document segments.

In some embodiments, the query response generating module is further configured to: generate a prompt input for a target model based at least on the at least one first document segment and the user query; provide the prompt input to the target model to obtain an output of the target model; and generate the query response to the user query based on the output of the target model.

In some embodiments, the structural information further indicates a data type in the target document, and the document segmenting module 510 is further configured to, in response to detecting that at least partial data of the target document contains data of a first data type and data a second data type, segment the at least partial data into a first document segment and a second document segment, the first document segment comprising the data of the first data type, and the second document segment comprising the data of the second data type.

In some embodiments, the document segmenting module 510 is further configured to segment the target document into a plurality of document segments further based on a dimension of the document vectorized representations to be generated.

In some embodiments, the hierarchical structure of the target document comprises a document tree structure of the target document, and the document segmenting module 510 is further configured to: for data corresponding to respective leaf nodes in the document tree structure, segment the target document into a plurality of document segments based at least on a semantic analysis result of the data corresponding to the respective leaf nodes.

In some embodiments, the apparatus 500 further comprises: an enhancement data generating module configured to generate enhancement data for at least a portion of the target document, wherein the at least a portion of the target document comprises at least one document segment of the plurality of document segments, the enhancement data comprising at least one of: a reference question and answer pair constructed based on the at least a portion of the target document, or summary information extracted from the at least a portion of the target document; an enhancement vector generating module configured to generate an enhancement vectorized representation of the enhancement data; and an association storage module configured to store the enhancement vectorized representation in association with at least one respective document vectorized representation of the at least one document segment.

In some embodiments, the apparatus 500 further comprises a query response determining module configured to, in response to one or more of the at least one document segment being determined as matching the user query, determine a query response to a user query based on the one or more document segments and the enhancement data.

The units and/or modules included in the apparatus 500 may be implemented in a variety of ways, including software, hardware, firmware, or any combination thereof. In some embodiments, one or more units and/or modules may be implemented using software and/or firmware, such as machine-executable instructions stored on a storage medium. In addition to or as an alternative to machine executable instructions, some or all of the units and/or modules in the apparatus 500 may be implemented, at least in part, by one or more hardware logic components. For example, and not limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

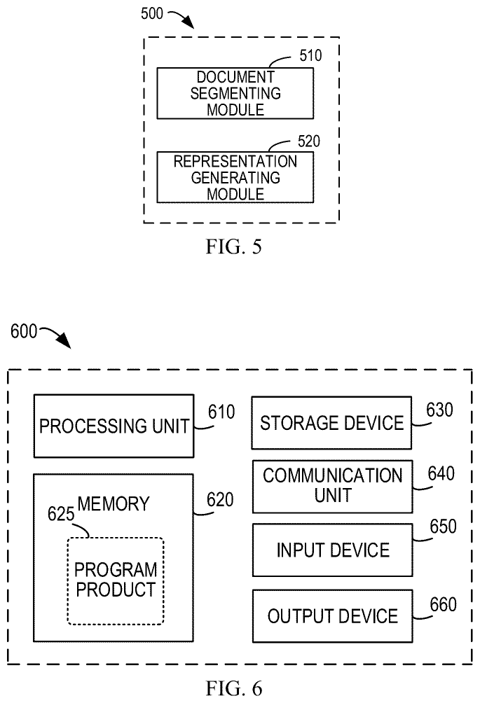

FIG. 6 illustrates a block diagram of an example electronic device 600 that can implement one or more embodiments of the present disclosure. It should be understood that the electronic device 600 shown in FIG. 6 is only exemplary and shall not constitute any limitation on the functions and scope of the embodiments described herein. The electronic device 600 shown in FIG. 6 can be used to implement the electronic device 110 in FIG. 1, and/or the apparatus 500 in FIG. 5.

As shown in FIG. 6, the electronic device 600 is in the form of a general-purpose electronic device. Components of the electronic device 600 may include, but are not limited to, one or more processors or processing units 610, a memory 620, a storage device 630, one or more communications units 640, one or more input devices 650, and one or more output devices 660. The processing unit 610 may be an actual or virtual processor and can perform various processes according to programs stored in the memory 620. In a multiprocessor system, a plurality of processing units execute computer executable instructions in parallel, so as to improve the parallel processing capability of the electronic device 600.

The electronic device 600 typically includes a number of computer storage media. Such media may be any available media that are accessible by electronic device 600, including, but not limited to, volatile and non-volatile media, removable and non-removable media. The memory 620 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium such as a flash drive, a magnetic disk, or any other medium that can be used to store information and/or data and that can be accessed within the electronic device 600.

The electronic device 600 may further include additional removable/non-removable, volatile/nonvolatile storage media. Although not shown in FIG. 6, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 implements communication with other electronic devices through a communication medium. In addition, functions of components of the electronic device 600 may be implemented by a single computing cluster or a plurality of computing machines, and these computing machines can communicate through a communication connection. Thus, the electronic device 600 may operate in a networked environment using logical connections to one or more other servers, network personal computers (PCs), or a father network node.

The input device 650 may be one or more input devices such as a mouse, keyboard, trackball, etc. The output device 660 may be one or more output devices such as a display, speaker, printer, etc. The electronic device 600 may further communicate with one or more external devices (not shown) such as a storage device, a display device, or the like through the communication unit 640 as required and communicate with one or more devices that enable a user to interact with the electronic device 600, or communicate with any device (e.g., a network card, a modem, or the like) that enables the electronic device 600 to communicate with one or more other electronic devices. Such communication may be performed via an input/output (I/O) interface (not shown).

According to an example implementation of the present disclosure, a computer readable storage medium is provided, on which a computer-executable instruction is stored, wherein the computer executable instruction is executed by a processor to implement the above-described method. According to an example implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may further be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some updated implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description provides examples, not exhaustive, and the present application is not limited to the implementations as disclosed. Many modifications and variations will be apparent to one of ordinary skill in the art without departing from the scope and spirit of the implementations as described. The selection of terms used herein is intended to best explain the principles of the implementations, the practical application, or improvements to technologies in the marketplace, or to enable others of ordinary skill in the art to understand the implementations disclosed herein.

1. A method of query processing, comprising:
segmenting a target document into a plurality of document segments, the segmenting being at least based on structural information of the target document and a semantic analysis result of the target document, the structural information at least indicating a hierarchical structure of the target document;
generating a respective document vectorized representation of each of the plurality of document segments; and
using the document vectorized representations to perform data retrieval against the target document.

2. The method of claim 1, wherein segmenting the target document into a plurality of document segments comprises:
segmenting the target document into a plurality of document segments based on the structural information of the target document and the semantic analysis result of the target document such that a length of each document segment is selected to maintain semantic integrity of the document segment.

3. The method of claim 1, further comprising:
in response to receiving a user query, generating a query vectorized representation corresponding to the user query;
determining a plurality of match degrees between the query vectorized representation and respective document vectorized representations of the plurality of document segments;
selecting, from the plurality of document segments, at least one first document segment matching the user query based on the determined plurality of match degrees; and
generating a query response to the user query based at least on the at least one first document segment.

4. The method of claim 3, wherein generating the query response to the user query based on the at least one document segment comprises:
determining, from the plurality of document segments, at least one second document segment having semantic relevance with the at least one first document segment based on the structural information of the target document and a semantic context of the at least one first document segment in the target document; and
generating a query response to the user query based on the at least one first document segment and the at least one second document segment.

5. The method of claim 4, wherein determining the at least one second document segment comprises at least one of:
for each of the at least one first document segment, in response to determining that a document portion of a predetermined granularity in which the first document segment is located comprises at least one further document segment, determining the at least one further document segment as the at least one second document segment; or
for each of the at least one first document segment, determining at least one further document segment of the plurality of document segments as the at least one second document segment based on a semantic relevance between the first document segment and a further document segment of the plurality of document segments.

6. The method of claim 3, wherein generating the query response to the user query based at least one the at least one first document segment comprises:
generating a prompt input for a target model based at least on the at least one first document segment and the user query;
providing the prompt input to the target model to obtain an output of the target model; and
generating the query response to the user query based on the output of the target model.

7. The method of claim 1, wherein the structural information further indicates a data type in the target document, and wherein segmenting the target document into a plurality of document segments comprises:
in response to detecting that at least partial data of the target document contains data of a first data type and data a second data type, segmenting the at least partial data into a first document segment and a second document segment, the first document segment comprising the data of the first data type, and the second document segment comprising the data of the second data type.

8. The method of claim 1, wherein segmenting the target document into a plurality of document segments comprises:
segmenting the target document into a plurality of document segments further based on a dimension of the document vectorized representations to be generated.

9. The method of claim 1, wherein the hierarchical structure of the target document comprises a document tree structure of the target document, and wherein segmenting the target document into a plurality of document segments comprises:
for data corresponding to respective leaf nodes in the document tree structure, segmenting the target document into a plurality of document segments based at least on a semantic analysis result of the data corresponding to the respective leaf nodes.

10. The method of claim 1, further comprising:
generating enhancement data for at least a portion of the target document, wherein the at least a portion of the target document comprises at least one document segment of the plurality of document segments, the enhancement data comprising at least one of: a reference question and answer pair constructed based on the at least a portion of the target document, or summary information extracted from the at least a portion of the target document;
generating an enhancement vectorized representation of the enhancement data; and
storing the enhancement vectorized representation in association with at least one respective document vectorized representation of the at least one document segment.

11. The method of claim 10, further comprising:
in response to one or more of the at least one document segment being determined as matching a user query, determining a query response to the user query based on the one or more document segments and the enhancement data.

12. An electronic device, comprising:
at least one processing unit; and
at least one memory coupled to the at least one processing unit and storing instructions executable by the at least one processing unit, the instructions, when executed by the at least one processing unit, causing the electronic device to perform operations comprising:
segmenting a target document into a plurality of document segments, the segmenting being at least based on structural information of the target document and a semantic analysis result of the target document, the structural information at least indicating a hierarchical structure of the target document;
generating a respective document vectorized representation of each of the plurality of document segments; and
using the document vectorized representations to perform data retrieval against the target document.

13. The electronic device of claim 12, wherein segmenting the target document into a plurality of document segments comprises:
segmenting the target document into a plurality of document segments based on the structural information of the target document and the semantic analysis result of the target document such that a length of each document segment is selected to maintain semantic integrity of the document segment.

14. The electronic device of claim 12, wherein the operations further comprise:
in response to receiving a user query, generating a query vectorized representation corresponding to the user query;
determining a plurality of match degrees between the query vectorized representation and respective document vectorized representations of the plurality of document segments;
selecting, from the plurality of document segments, at least one first document segment matching the user query based on the determined plurality of match degrees; and
generating a query response to the user query based at least on the at least one first document segment.

15. The electronic device of claim 14, wherein generating the query response to the user query based on the at least one document segment comprises:
determining, from the plurality of document segments, at least one second document segment having semantic relevance with the at least one first document segment based on the structural information of the target document and a semantic context of the at least one first document segment in the target document; and
generating a query response to the user query based on the at least one first document segment and the at least one second document segment.

16. The method of claim 15, wherein determining the at least one second document segment comprises at least one of:
for each of the at least one first document segment, in response to determining that a document portion of a predetermined granularity in which the first document segment is located comprises at least one further document segment, determining the at least one further document segment as the at least one second document segment; or
for each of the at least one first document segment, determining at least one further document segment of the plurality of document segments as the at least one second document segment based on a semantic relevance between the first document segment and a further document segment of the plurality of document segments.

17. The method of claim 14, wherein generating the query response to the user query based at least one the at least one first document segment comprises:
generating a prompt input for a target model based at least on the at least one first document segment and the user query;
providing the prompt input to the target model to obtain an output of the target model; and
generating the query response to the user query based on the output of the target model.

18. The electronic device of claim 12, wherein the structural information further indicates a data type in the target document, and wherein segmenting the target document into a plurality of document segments comprises:
in response to detecting that at least partial data of the target document contains data of a first data type and data a second data type, segmenting the at least partial data into a first document segment and a second document segment, the first document segment comprising the data of the first data type, and the second document segment comprising the data of the second data type.

19. The electronic device of claim 12, wherein segmenting the target document into a plurality of document segments comprises:
segmenting the target document into a plurality of document segments further based on a dimension of the document vectorized representations to be generated.

20. A non-transitory computer-readable storage medium having a computer program stored thereon, wherein the computer program is executable by a processor to perform operations comprising:
segmenting a target document into a plurality of document segments, the segmenting being at least based on structural information of the target document and a semantic analysis result of the target document, the structural information at least indicating a hierarchical structure of the target document;
generating a respective document vectorized representation of each of the plurality of document segments; and
using the document vectorized representations to perform data retrieval against the target document.
